(19) United States
(12) Patent Application Publication
(10) Pub. No.: US 2022/0164317 A1
(43) Pub. Date: May 26, 2022

(54) REMOTE FILE ACCESS APPARATUS AND METHOD THEREOF

(71) Applicant: QNAP Systems, Inc., New Taipei City (TW)

(72) Inventors: Jing-Wei Su, New Taipei City (TW); Chin-Tsung Cheng, New Taipei City (TW)

(21) Appl. No.: 17/194,357

(22) Filed: Mar. 8, 2021

(30) Foreign Application Priority Data
Nov. 24, 2020 (TW) 109141094

(51) Int. Cl. G06F 16/182; G06F 9/48; H04L 29/08

(52) U.S. Cl. CPC G06F 16/183; H04L 67/06; G06F 9/4881

(57) ABSTRACT

A remote file access apparatus and a corresponding method are provided. An access score corresponding to an access instruction is generated, and the approach to process the access instruction is determined when the access instruction is going to access data external to the remote file access apparatus, wherein the access score is calculated according to an access information of the access instruction and the access information includes at least one of a type of an application requesting the access instruction, a related information of a user requesting the access instruction and at least one attribute of a file accessed by the access instruction.

### BACKGROUND

### 1. Technical Field

The present disclosure relates to a cloud (remote) accessing technology. In particular, the present disclosure further relates to a remote file access apparatus and a corresponding method.

### 2. Description of Related Art

A cloud (remote) file means a file stored in a remote server. By storing files that are usually not needed in remote servers, users can reduce the amount of data stored in terminal devices on hand, such as smart phones, laptop computers, or network attached storages (NAS), and access the required data from the servers only when necessary. Therefore, an access operation of the cloud file has been a frequently used technology. However, due to the increasing computing power of terminal devices, the number of applications that a user can run at the same time increases accordingly, and every time the access operation of the cloud file is performed, data must be transmitted through various networks. Therefore, how to properly arrange the execution sequence of the access operations of the cloud file has become an important issue.

### SUMMARY

A remote file access apparatus is provided, including a file management unit, an access management unit, a transmission proxy unit, and a scheduling control unit. The file management unit sends a corresponding access instruction when a cloud (remote) apparatus is needed for accessing a file. The access management unit is connected to the file management unit to receive the access instruction. In addition, the access management unit sends access information according to the access instruction, receives an access score in response to the access information, and outputs the access score and the corresponding access instruction, wherein the access information includes the type of an application requesting the access instruction, related information of a user requesting the access instruction, or at least one attribute of the file accessed by the access instruction. The transmission proxy unit is connected to the access management unit to receive the access score and the corresponding access instruction. The transmission proxy unit refers to the access score to determine a processing approach of the corresponding access instruction. The scheduling control unit is connected to the access management unit to receive the access information and generate the access score corresponding to the access information according to the received access information.

In an embodiment, the at least one attribute of the file accessed by the access instruction includes file size, file format, previous file access time (atime), file change time (ctime), and file modified time (mtime).

In an embodiment, the access information further includes allowed download time and an allowed transmission bandwidth.

In an embodiment, the transmission proxy unit includes a plurality of work queues, a work scheduling element, and a queue policy management element. The work scheduling element is connected to the access management unit to receive the access score and the access instruction, wherein the access instruction corresponds to the access score. The work scheduling element dispatches the access instruction to one of the work queues according to a preset rule and the access score. The queue policy management element provides the preset rule to the work scheduling element, assigns access instructions in different work queues with different processing time lengths, and assigns different access instructions with different processing time lengths in the same work queue.

In an embodiment, the transmission proxy unit includes a work queue, a work scheduling element, and a queue policy management element. The work scheduling element is connected to the access management unit to receive the access score and the access instruction corresponding to the access score, and assigns a corresponding processing time length to the access instruction according to a preset rule and the access score. The queue policy management element provides the preset rule to the work scheduling element.

In an embodiment, the transmission proxy unit further obtains a network status of an outward connection of the remote file access apparatus. In addition, the scheduling control unit is connected to the transmission proxy unit to receive the network status and generate the access score according to the access information and the network status.

In an embodiment, the network status includes a network history of the remote file access apparatus, and the scheduling control unit predicts a next network status of the remote file access apparatus in the future according to the network history and generates the access score according to the next network status and the access information.

A remote file access method is provided. When an access instruction is an access instruction that needs to access data external to the remote file access apparatus, the aforementioned method generates an access score corresponding to the access instruction. In addition, the aforementioned method determines a processing approach of the corresponding access instruction according to the access score, wherein the access score is calculated according to access information of the access instruction, and the access information includes the type of an application requesting the access instruction, related information of a user requesting the access instruction, or at least one attribute of a file accessed by the access instruction.

In an embodiment, the at least one attribute of the file accessed by the access instruction includes file size, file format, previous file access time (atime), file change time (ctime), and file modified time (mtime).

In an embodiment, the access information further includes allowed download time and an allowed transmission bandwidth.

Based on the above technology, the remote file access apparatus and the corresponding method provided by the present disclosure can be used to arrange the processing approach of each access instruction, and therefore the remote file access apparatus and the corresponding method can arrange and control the execution priority of each access operation of the cloud file. Further, the present disclosure can also minimize the possibility of network congestion based on existing network usage status and network history data.

### BRIEF DESCRIPTION OF THE DRAWINGS

The present disclosure can be more fully understood by reading the following descriptions of the embodiments, with reference made to the accompanying drawings.

FIG. 1 is a schematic architecture diagram of a system using a remote file access apparatus according to an embodiment of the present disclosure.

FIG. 2 is a schematic architecture diagram of a scheduling control unit according to an embodiment of the present disclosure.

FIG. 3A is a schematic architecture diagram of a transmission proxy unit according to an embodiment of the present disclosure.

FIG. 3B is a schematic architecture diagram of a transmission proxy unit according to an embodiment of the present disclosure.

FIG. 4 is a schematic architecture diagram of a remote file access apparatus according to another embodiment of the present disclosure.

FIG. 5 is a schematic architecture diagram of a scheduling control unit according to another embodiment of the present disclosure.

FIG. 6 is a flow chart of a remote file access method according to an embodiment of the present disclosure.

### DETAILED DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

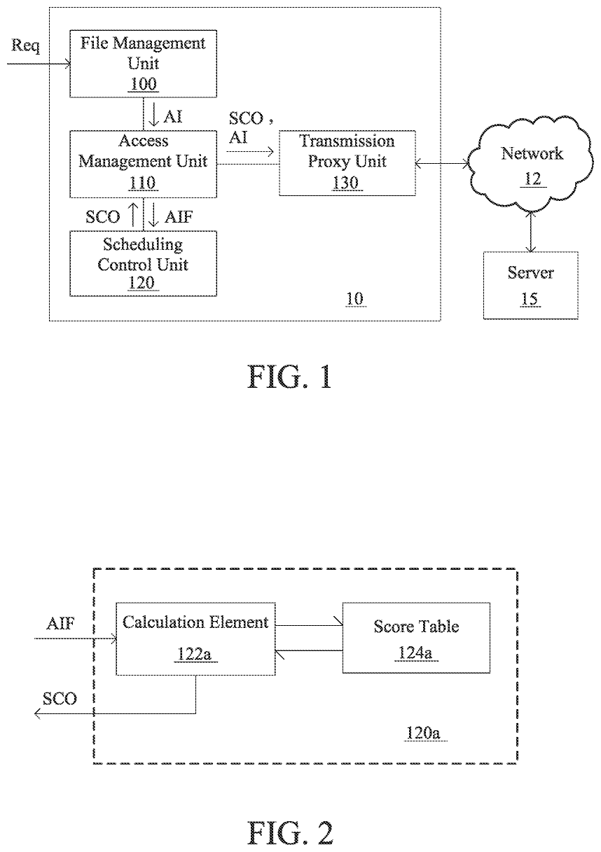

Please refer to FIG. 1, which is a schematic architecture diagram of a system using a remote file access apparatus according to an embodiment of the present disclosure. The system shown in FIG. 1 includes a remote file access apparatus 10, a server 15, and a network 12 connected between the remote file access apparatus 10 and the server 15 for transmitting data, wherein an access management unit 110 is connected to a file management unit 100, a scheduling control unit 120, and a transmission proxy unit 130 to perform data transmission operations with the file management unit 100, the scheduling control unit 120, and the transmission proxy unit 130, respectively.

The remote file access apparatus 10 may be any electronic apparatus including a processor or a central processing unit (CPU), such as a smart phone, a laptop computer, a personal computer, a computer installed in a car or a vehicle, or an NAS. The server 15 may be a local server, a remote server, a cloud server, or an NAS.

When a part of the remote file access apparatus 10 is described to be connected to another part of the remote file access apparatus 10, it means those two parts of the remote file access apparatus 10 may be connected through a hardware electrical connection, a wired network or a wireless network. The same interpretation is applicable to the following connections between any two parts of the remote file access apparatus 10.

Since the remote file access apparatus 10 is connected to the server 15 via the network 12, for the remote file access apparatus 10, the operations of writing data to the server 15 or the operations of obtaining data from the server 15 belong to access operations of cloud (remote) files. As a person skilled in the art knows, each access operation of the cloud file occupies a part of the transmission bandwidth of the network 12, so the access operations of the cloud file that can be performed at the same time are limited. Furthermore, The network 12 may be connected to more than one remote file access apparatus and more than one server at the same time. Therefore, when the transmission bandwidth of the network 12 may be shared by multiple apparatuses, it is very important to properly manage the access operations of the cloud file so that each apparatus can run smoothly.

Please continue referring to FIG. 1. In this embodiment, the remote file access apparatus 10 includes a file management unit 100, an access management unit 110, a scheduling control unit 120, and a transmission proxy unit 130. When receiving a file access request Req from an application, the file management unit 100 first determines whether the file to be accessed is a local file, that is, the file is stored in a memory element (such as a hard disk or a memory) of the remote file access apparatus 10. When the file to be accessed is a local file, the file management unit 100 informs the access management unit 110 to obtain the related file from a corresponding storage location in the remote file access apparatus 10 and return the obtained contents to the application. On the other hand, when the file to be accessed is a cloud file instead of a local file, that is, when the file has to be obtained from another location (such as the server 15) through the network 12, the file management unit 100 sends out a corresponding access instruction AI to the access management unit 110. The access instruction AI here can include the application that issued the corresponding file access request Req, the related information of the user of this application, the name and the attributes of the file requested for access, the contents to be written into the cloud file or the location storing the contents to be written, or the data sections to be obtained from the cloud file, etc. A person skilled in the art should know that the contents included in the access instruction AI can be changed, added or deleted according to different communication standards and different actual requirements. The contents included in the access instruction AI listed above are only a possible implementation, and the present disclosure is not limited to this specific condition.

As shown in FIG. 1, the access management unit 110 is connected to the file management unit 100 to receive the access instruction AI. After receiving the access instruction AI, the access management unit 110 sends the corresponding access information AIF to the scheduling control unit 120 according to the received access instruction AI, and then, after receiving the access score SCO generated in response to the access information AIF from the scheduling control unit 120, the access management unit 110 outputs the access score SCO and the corresponding access instruction AI to the transmission proxy unit 130. In this embodiment, the access information AIF can be obtained from the access instruction AI by the access management unit 110. For example, as mentioned above, the access information AIF can include the application that issued the corresponding file access request Req, the related information of the user of this application, the name and the attributes of the file requested for access, the contents to be written into the cloud file or the location storing the contents to be written, or the data sections to be obtained from the cloud file included in the access instruction AI. In other embodiments, the access information AIF can be provided to the access management unit 110 by the operating system controlling the remote file access apparatus 10 through other channels. A person skilled in the art can perform the related design of the obtaining of the access information AIF by the access management unit 110 according to actual requirements, and does not have to be limited to the two embodiments listed above.

Next, please also refer to FIG. 2, which is a schematic architecture diagram of a scheduling control unit according to an embodiment of the present disclosure.

In this embodiment, the scheduling control unit 120a includes a calculation element 122a and a score table 124a. After receiving the access information AIF, the calculation element 122a queries the contents of the score table 124a according to the information in the access information AIF, performs calculation based on the result obtained from the query according to a preset formula, and generates the access score SCO provided to the access management unit 110.

In an embodiment, the access information AIF can include the application requesting the corresponding access instruction as mentioned above, and the score of each application can be placed in the score table 124a; or, under a similar concept, the access information AIF can include the type of the application requesting the corresponding access instruction, such as an application running in the background or an application requiring immediate response, and the scores of different types of applications are placed in the score table 124a. In another embodiment, the access information AIF can include the related data of the user (or user group) requesting the corresponding access instruction, and the score of each user (or user group) is placed in the score table 124a. In another embodiment, the access information AIF can include the attributes of the file to be accessed, such as file size, file format, previous file access time (atime), file change time (ctime), and file modified time (mtime), etc.; and scores corresponding to parameters such as ranges of file sizes, types of file formats, difference between the previous file access time and the current time, between the file change time and the current time, or between the file modified time and the current time are correspondingly placed in the score table 124a.

For example, the data of the score table 124a can be as shown in Table 1 below:

TABLE 1

| Application | Applications running in | | Applications running in the | | |
|---|---|---|---|---|---|
| type (S1) | the foreground (10) | | background (2) | | |
| user group | group 1 | | group 2 | | group 3 |
| (S2) | (5) | | (7) | | (10) |
| file size | <4k | 4k~200k | 200k~1M | 1M~3M | >3M |
| (S3) | (10) | (7) | (5) | (3) | (1) |

| | | | |
|---|---|---|---|
| file format | text file | image file | video file |
| (S4) | (2) | (5) | (8) |
| file change | <10 minutes | 10 minutes~1 hour | >1 hour |
| time (S5) | (10) | (5) | (2) |

According to Table 1, an application A executed by a user of group 2 in the background can get 2 points in the first score category S1 and 7 points in the second score category S2, while the application A can get 7 points in the third score category S3, 2 points in the fourth score category S4 and 2 points in the fifth score category S5 when the application A requests a text file with a previous modification time at 3 hours ago and a size of 10 k bits. When the calculation element 122a uses direct accumulation for score calculation, that is, S1+S2+S3+S4+S5, then the access score SCO of the access instruction (such as AI in FIG. 1) issued according to the request of the application A (such as Req in FIG. 1) this time is 20 points.

It should be noted that the contents of the score table 124a can also include other types of scores. For example, the score table 124a can also assign scores according to parameters such as allowed download time or allowed transmission bandwidths of the applications, as shown in Table 2 below:

TABLE 2

| Allowed download time | 9 am~5 pm (0) | | 5 pm~9 am (1) |
|---|---|---|---|
| of application A (T) | | | |
| Allowed download time | 9 am~5 pm (1) | | 5 pm~9 am (0) |
| of application B (T) | | | |
| Allowed transmission | <10k/sec | 10k/sec~30k/sec | >30k/sec |
| bandwidth (BW) | (3) | (6) | (10) |

In Table 2, the allowed download time of the application A and that of the application B are not the same. When the application A requests to download in the time period from 5 pm to 9 am, the application A can obtain 1 point in the time score category T. On the contrary, when the application A requests to download in the time period from 9 am to 5 pm, the application A obtains 0 point in the time score category T. On the other hand, when the application B requests to download in the time period from 5 pm to 9 am, the application B obtains 0 point in the time score category T. On the contrary, when the application B requests to download in the time period from 9 am to 5 pm, the application B can obtain 1 point in the time score category T. With this design, the present disclosure can assign different network usage time periods to different applications. In addition, when the network transmission bandwidth an application is allowed in advance to occupy is higher, the application can probably obtain more points in the bandwidth score category BW when the application requests cloud (remote) access.

When introducing the time score T and the bandwidth score BW, the calculation element 122a can use other calculation methods to calculate the access score SCO. For example, the calculation element 122a can use the following formula (1) to calculate the access score SCO:

SCO=(S1+S2+S3+S4+S5)*T*BW (1)

Of course, the calculation element 122a can also use other calculation formulas to calculate the access score SCO. Different calculation formulas can be derived by a person skilled in the art according to actual requirements and with reference to the description of the present disclosure. In order to make the description concise and clear, no further examples are given here.

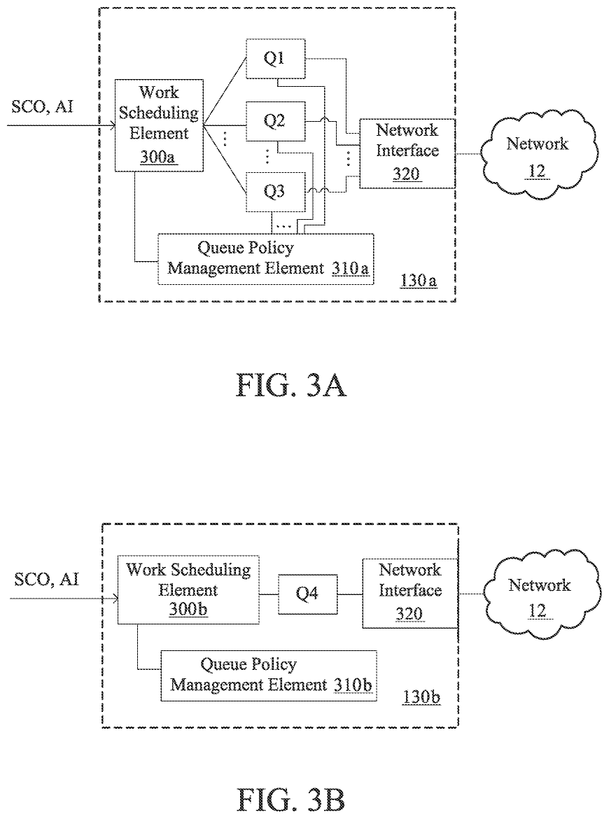

Please refer to FIG. 1 again. After obtaining the access score SCO from the scheduling control unit 120, the access management unit 110 outputs the access score SCO and the corresponding access instruction AI to the transmission proxy unit 130, and then the transmission proxy unit 130 refers to the access score SCO to determine the processing approach of the corresponding access instruction AI. Next, please also refer to FIG. 3A. In this embodiment, the transmission proxy unit 130a includes several work queues Q1, Q2 . . . Q3, a work scheduling element 300a, a queue policy management element 310a, and a network interface 320. The work scheduling element 300a is connected to the access management unit 110 to receive the access score SCO and the access instruction AI corresponding to the access score SCO, and dispatches the corresponding access instruction AI to one of the work queues Q1, Q2 . . . Q3 according to a preset rule provided by the queue policy management element 310a and the received access score SCO.

Specifically, the preset rule provided by the queue policy management element 310a in this embodiment includes the relationship between score ranges and the work queues. For example, an access score SCO located in a highest preset range (for example, greater than 40) corresponds to the work queue Q1, an access score SCO in a certain preset range (for example, 30-40) corresponds to the work queue Q2, and so on, until an access score SCO located in the lowest preset range (for example, greater than 0 and less than 5) corresponds to the work queue Q3. In this way, the work scheduling element 300a can determine how to arrange the corresponding access instruction AI according to the received access score SCO and the aforementioned preset rule.

It should be noted that the preset rule provided by the queue policy management element 310a can be adjusted manually or automatically at any time. Moreover, in addition to providing the preset rule determined in advance to the work scheduling element 300a, the queue policy management element 310a can further determine other management methods. For example, the queue policy management element 310a can set the processing priority of the work queues Q1˜Q3, so that all access instructions AI in the work queue Q1 must be processed before the access instructions AI in the work queue Q2 can be processed, and the access instructions AI in all of the other work queues must be processed before the access instructions AI in the last work queue Q3 can be processed. Alternatively, the access instructions AI in all work queues must be processed in a circular manner. For example, first, process the access instructions AI in the work queue Q1 for a first period of time (for example, 5 seconds), and then process the access instructions AI in the work queue Q2 for a second period of time (for example, 2 seconds), and finally process the access instructions AI in the last work queue Q3 for a third period of time (for example, 0.5 seconds), and then the access instructions AI in the work queues Q1˜Q3 are processed in this sequence repeatedly. In another embodiment, the queue policy management element 310a can simply assign a corresponding processing time length to each access instruction AI. For example, the queue policy management element 310a can make each access instruction AI in the work queue Q1 has the same processing time length t1, and make each access instruction AI in the work queue Q2 has the same processing time length t2, . . . and make each access instruction AI in the work queue Q3 has the same processing time length t3, wherein the processing time lengths t1, t2 and t3 are different from each other.

The transmission proxy unit that can be used in the present invention is not limited to the foregoing embodiment. For example, please refer to FIG. 3B, which is a schematic architecture diagram of the transmission proxy unit according to an embodiment of the present disclosure. In this embodiment, the transmission proxy unit 130b uses only one work queue Q4. Similarly, the work scheduling element 300b is connected to the access management unit 110 to receive the access score SCO and the access instruction AI corresponding to the access score SCO. The difference is that the work scheduling element 300b directly allocates a processing time length to the corresponding access instruction AI only according to the preset rule provided by the queue policy management element 310a and the received access score SCO. Multiple access instructions AI are arranged one by one in the work queue Q4 according to the time when they are transmitted to the work scheduling element 300b to wait to be processed in sequence. Here, the preset rule provided by the queue policy management element 310b can simply include only the relationship between the access scores and the processing time lengths to reduce the complexity of the design.

As a person skilled in the art knows, the aforementioned access instruction AI will finally perform a data transmission operation with the network 12 through the operation of the network interface 320. Since the existing network interface 320 or the operating system controlling the network interface 320 can detect and record the current bandwidth usage of the network 12 connected to it, therefore these data can be further used in other embodiments to determine the processing approaches of the access instructions.

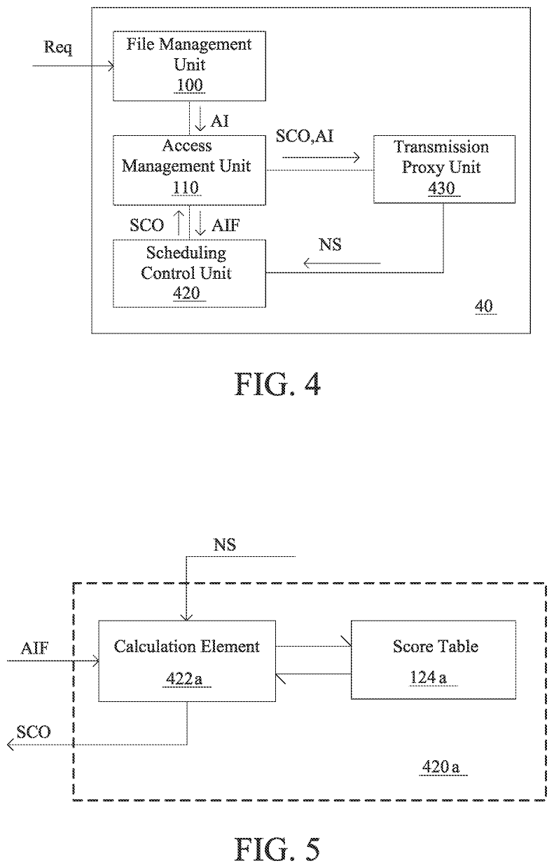

Please refer to FIG. 4, which is a schematic architecture diagram of a remote file access apparatus according to another embodiment of the present disclosure. The difference between the remote file access apparatus 40 in this embodiment and the remote file access apparatus 10 in FIG. 1 is that the scheduling control unit 420 of the remote file access apparatus 40 is further connected to the transmission proxy unit 430. The transmission proxy unit 430 can be implemented according to FIG. 3A, FIG. 3B or other architectures, and the transmission proxy unit 430 can provide the outward network status NS of the remote file access apparatus 40 (for example, the aforementioned bandwidth usage of the network 12) detected by the network interface 320 to the scheduling control unit 420. The scheduling control unit 420 further uses the obtained network status NS to calculate the access score SCO of each access instruction AI. Although a person skilled in the art can refer to FIG. 5 to learn a feasible architecture of the scheduling control unit 420, the present disclosure is not limited thereto.

For example, in order to adjust the access score SCO according to the network status, the calculation element 422a in the scheduling control unit 420a can use the following formula (2) to calculate the access score SCO:

SCO=(S1+S2+S3+S4+S5)*T*BW*Y1 (2)

Y1 in formula (2) is the ratio of the current available bandwidth to the maximum available bandwidth obtained in the network status NS. By introducing the parameter Y1, the access score SCO that can be obtained by the same access instruction AI will decrease when the current available bandwidth decreases, which may further reduce the processing time the access instruction AI obtains. Consequently, by introducing the parameter Y1, the remote file access apparatus 40 can adjust its network bandwidth requirement as the current status of network connection changes, reducing the possibility of network congestion.

In another embodiment, the aforementioned network status NS can further include the network history of outward connections of the remote file access apparatus 40, and the scheduling control unit 420 can predict the next network status of the remote file access apparatus 40 in a future period of time based on the network history and generate the corresponding access score according to the obtained next network status and the access information. For example, in order to adjust the access score SCO based on the network history (or the next network status), the calculation element 422a in the scheduling control unit 420a can use the following formula (3) to calculate the access score SCO:

SCO=(S1+S2+S3+S4+S5)*T*BW*Y2 (3)

Among them, Y2 in formula (3) is the ratio of the possible available bandwidth to the maximum available bandwidth in a certain period of time in the future obtained by network status prediction based on the historical record obtained from the network status NS.

In addition to the above operations, the scheduling control unit can also obtain the total available bandwidth from the network status NS. In an embodiment, when the total available bandwidth is below a certain value (for example, the total available bandwidth is not enough for the existing cloud access requests), the scheduling control unit can calculate the access score SCO based on the data in the existing score table. In contrast, when the total available bandwidth is large enough (for example, there is extra space after the total available bandwidth is provided to the existing cloud access requests), the scheduling control unit can directly increase the access score SCO calculated according to each aforementioned formula (for example, multiply the access score SCO by a value greater than 1) to maximize the bandwidth used to complete cloud file access operations more quickly.

Alternatively, in another embodiment, when the total available bandwidth is large enough (for example, there is extra space after the total available bandwidth is provided to the existing cloud access requests), the scheduling control unit can also determine whether the network bandwidth is about to be heavily occupied based on the network history. If it is determined that the network bandwidth is about to be heavily occupied, then the scheduling control unit does not increase the access score SCO calculated according to each aforementioned formula. On the other hand, if it is determined that the network bandwidth will not be heavily occupied in a short time in the future, then the scheduling control unit can increase the access score SCO calculated according to each aforementioned formula (for example, multiply the access score SCO by a value greater than 1) to expand the bandwidth used as much as possible.

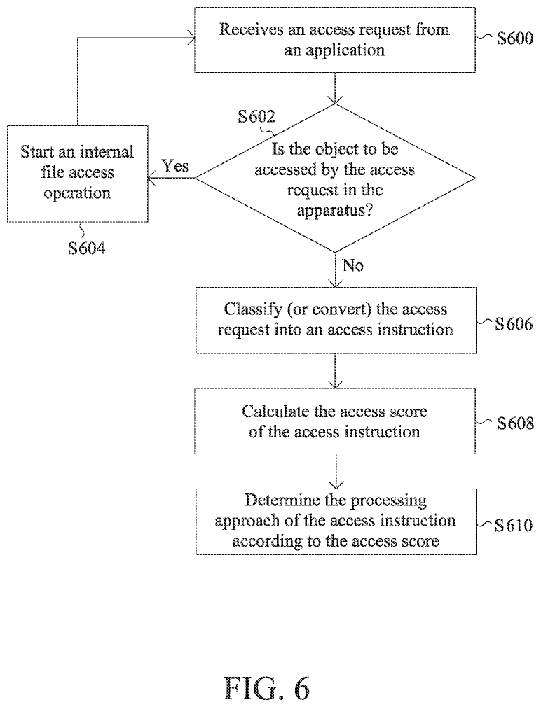

Based on the above description, the present disclosure further provides a remote file access method. Please refer to FIG. 6, which is a flow chart of a remote file access method according to an embodiment of the present disclosure.

As shown in FIG. 6, this embodiment first receives an access request from an application (step S600), and then determines whether the object to be accessed by this access request is in a remote file access apparatus (step S602). When the object to be accessed is a file in the remote file access apparatus, start a general internal file access operation (step S604) and then wait to receive another access request. On the contrary, when the object to be accessed is a file outside the remote file access apparatus, classify (or convert) the access request into an access instruction suitable for accessing a file via an external network (step S606), and then calculate the access score of this access instruction (step S608), and then determine the processing approach of this access instruction according to the obtained access score (step S610). The processing details of the foregoing steps can be known from the descriptions of the foregoing embodiments, and will not be repeated here.

In summary, based on the above technology, the remote file access apparatus and the corresponding method provided by the present disclosure can be used to arrange the processing approach of each access instruction, therefore the remote file access apparatus and the corresponding method can control the execution priority of each access operation of the cloud file. Further, the present disclosure can also minimize the possibility of network congestion based on existing network usage status and network history data.

What is claimed is:

1. A remote file access apparatus, comprising:
a file management unit configured for sending an access instruction when the remote file access apparatus needs to access a file on a server;
an access management unit connected to the file management unit and configured for receiving the access instruction, wherein the access management unit sends an access information according to the access instruction, receives an access score in response to the access information, and outputs the access score and the access instruction, and wherein the access information comprises at least one of a type of an application requesting the access instruction, a related information of a user requesting the access instruction, and at least one attribute of the file accessed by the access instruction;
a transmission proxy unit connected to the access management unit and configured for receiving the access score and the access instruction, wherein the transmission proxy unit refers to the access score to determine a processing approach of the access instruction; and
a scheduling control unit connected to the access management unit and configured for receiving the access information and generating the access score according to the access information.

2. The remote file access apparatus according to claim 1, wherein the at least one attribute of the file accessed by the access instruction comprises at least one of file size, file format, previous file access time (atime), file change time (ctime), and file modified time (mtime).

3. The remote file access apparatus according to claim 1, wherein the access information further comprises allowed download time and an allowed transmission bandwidth.

4. The remote file access apparatus according to claim 1, wherein the transmission proxy unit comprises:
a plurality of work queues;
a work scheduling element connected to the access management unit and configured for receiving the access score and the access instruction, wherein the access instruction corresponds to the access score, and the work scheduling element dispatches the access instruction to one of the work queues according to a preset rule and the access score; and
a queue policy management element configured for providing the preset rule to the work scheduling element, assigning access instructions in different work queues with different processing time lengths, and assigning different access instructions with different processing time lengths in a same one of the work queue.

5. The remote file access apparatus according to claim 1, wherein the transmission proxy unit comprises:
a work queue;
a work scheduling element connected to the access management unit and configured for receiving the access score and the access instruction corresponding to the access score, wherein the work scheduling element assigns a corresponding processing time length to the access instruction according to a preset rule and the access score; and
a queue policy management element configured for providing the preset rule to the work scheduling element.

6. The remote file access apparatus according to claim 1, wherein the transmission proxy unit further obtains a network status of an outward connection of the remote file access apparatus, and wherein the scheduling control unit is connected to the transmission proxy unit to receive the network status and generate the access score according to the access information and the network status.

7. The remote file access apparatus according to claim 6, wherein the network status comprises a network history of the remote file access apparatus, and wherein the scheduling control unit predicts a next network status of the remote file access apparatus in a future according to the network history and generates the access score according to the next network status and the access information.

8. A remote file access method applicable in a remote file access apparatus, comprising:
generating an access score corresponding to an access instruction when the access instruction needs to access data external to the remote file access apparatus; and
determining a processing approach of the access instruction according to the access score, wherein the access score is calculated according to an access information of the access instruction, and wherein the access information comprises at least one of a type of an application requesting the access instruction, a related information of a user requesting the access instruction, and at least one attribute of a file accessed by the access instruction.

9. The remote file access method according to claim 8, wherein the at least one attribute of the file accessed by the access instruction comprises at least one of file size, file format, previous file access time (atime), file change time (ctime), and file modified time (mtime).

10. The remote file access method according to claim 8, wherein the access information further comprises allowed download time and an allowed transmission bandwidth.

What is claimed is:

1. A remote file access apparatus, comprising:
a file management unit configured for sending an access instruction when the remote file access apparatus needs to access a file on a server;
an access management unit connected to the file management unit and configured for receiving the access instruction, wherein the access management unit sends an access information according to the access instruction, receives an access score in response to the access information, and outputs the access score and the access instruction, and wherein the access information comprises at least one of a type of an application requesting the access instruction, a related information of a user requesting the access instruction, and at least one attribute of the file accessed by the access instruction;
a transmission proxy unit connected to the access management unit and configured for receiving the access score and the access instruction, wherein the transmission proxy unit refers to the access score to determine a processing approach of the access instruction; and
a scheduling control unit connected to the access management unit and configured for receiving the access information and generating the access score according to the access information.

2. The remote file access apparatus according to claim 1, wherein the at least one attribute of the file accessed by the access instruction comprises at least one of file size, file format, previous file access time (atime), file change time (ctime), and file modified time (mtime).

3. The remote file access apparatus according to claim 1, wherein the access information further comprises allowed download time and an allowed transmission bandwidth.

4. The remote file access apparatus according to claim 1, wherein the transmission proxy unit comprises:
a plurality of work queues;
a work scheduling element connected to the access management unit and configured for receiving the access score and the access instruction, wherein the access instruction corresponds to the access score, and the work scheduling element dispatches the access instruction to one of the work queues according to a preset rule and the access score; and
a queue policy management element configured for providing the preset rule to the work scheduling element, assigning access instructions in different work queues with different processing time lengths, and assigning different access instructions with different processing time lengths in a same one of the work queue.

5. The remote file access apparatus according to claim 1, wherein the transmission proxy unit comprises:
a work queue;
a work scheduling element connected to the access management unit and configured for receiving the access score and the access instruction corresponding to the access score, wherein the work scheduling element assigns a corresponding processing time length to the access instruction according to a preset rule and the access score; and
a queue policy management element configured for providing the preset rule to the work scheduling element.

6. The remote file access apparatus according to claim 1, wherein the transmission proxy unit further obtains a network status of an outward connection of the remote file access apparatus, and wherein the scheduling control unit is connected to the transmission proxy unit to receive the network status and generate the access score according to the access information and the network status.

7. The remote file access apparatus according to claim 6, wherein the network status comprises a network history of the remote file access apparatus, and wherein the scheduling control unit predicts a next network status of the remote file access apparatus in a future according to the network history and generates the access score according to the next network status and the access information.

8. A remote file access method applicable in a remote file access apparatus, comprising:
generating an access score corresponding to an access instruction when the access instruction needs to access data external to the remote file access apparatus; and
determining a processing approach of the access instruction according to the access score, wherein the access score is calculated according to an access information of the access instruction, and wherein the access information comprises at least one of a type of an application requesting the access instruction, a related information of a user requesting the access instruction, and at least one attribute of a file accessed by the access instruction.

9. The remote file access method according to claim 8, wherein the at least one attribute of the file accessed by the access instruction comprises at least one of file size, file format, previous file access time (atime), file change time (ctime), and file modified time (mtime).

10. The remote file access method according to claim 8, wherein the access information further comprises allowed download time and an allowed transmission bandwidth.
